(19) United States
(12) Patent Application Publication
(10) Pub. No.: US 2016/0219931 A1
(43) Pub. Date: Aug. 4, 2016

(54) System and Apparatus to Effect Behavioral Change

(71) Applicants: Suraaj Doshi, Morrisville, NC (US); Kyle Linton, Morrisville, NC (US); Tarang Patel, Burlington, NC (US); Anirudh Mulukutla, Morrisville, NC (US); Ian Rogers, Morrisville, NC (US)

(72) Inventors: Suraaj Doshi, Morrisville, NC (US); Kyle Linton, Morrisville, NC (US); Tarang Patel, Burlington, NC (US); Anirudh Mulukutla, Morrisville, NC (US); Ian Rogers, Morrisville, NC (US)

(21) Appl. No.: 15/011,520

(22) Filed: Jan. 30, 2016

Related U.S. Application Data
(60) Provisional application No. 62/109,747, filed on Jan. 30, 2015.

(51) Int. Cl. A24F 15/00; H04L 29/08; A24F 47/00; G06F 17/30

(52) U.S. Cl. CPC A24F 15/005; G06F 17/30528; H04L 67/22; A24F 47/00

(57) ABSTRACT

This document presents a system and method for tracking the habits of smokers, make them aware of their habits and help them quit smoking. The system consists of an interconnected smart case, system server, and software App that is downloaded and operational on a mobile device associated with the user. The system tracks smoking activity, habits, and access to smoking materials such as cigarettes. The system also analyzes all collected information about each user to help predict when a user will next want to smoke and deter the user prior to smoking with inspirational messages, games or other activities presented on the mobile device.

### PRIORITY CLAIM

This Non-Provisional application claims under 35 U.S.C. §120, the benefit of priority to the Provisional Application 62/109,747, filed Jan. 30, 2015, and titled “BEHAVIORAL CHANGING DEVICE AND SYSTEM” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Worldwide, the smoking of tobacco causes more than six million deaths annually and is expected to increase every year (World Health Organization, 2015). Cigarette smoking is the leading cause of preventable death in the US, causing about one out of five, or 480,000 deaths in the US each year; smoking harms nearly every organ in the body, and an estimated 41,000 adults die in the U.S. each year due to secondhand smoke exposure, particularly due to lung cancer (7,333 deaths/year) and heart disease (33,951 deaths/year) (U.S. Department of Health and Human Services, 2014).

To address smoking cessation, many different methods and products are available in the current market. Some popular methods include prescription drugs, nicotine replacement therapies (NRTs), electronic cigarettes, and mobile apps supporting cold-turkey quit attempts. Other methods emphasize social support groups rather than a treatment plan, such as consulting smoking cessation counselors and psychiatrists.

The most commonly used methods are cold turkey and NRTs. Despite its popularity, however, the long-term success rates for cold-turkey are very low. NRTs are not very successful for long-term quitting either. A study found that 93% of over-the-counter NRT users relapse and return to smoking within six months (JR Hughes, et al.).

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of an exemplary system component configuration consistent with certain embodiments of the present invention.

FIG. 2 is a flow diagram for the smoking cessation application operation consistent with certain embodiments of the present invention.

FIG. 3 is a flow diagram for the operation of the software app within the system consistent with certain embodiments of the present invention.

FIG. 4 is a flow diagram for the operation of the smart case within the system consistent with certain embodiments of the present invention.

FIG. 5 is an operational flow diagram for software app operation when not connected to the smart case consistent with certain embodiments of the present invention.

FIG. 6 is a screen shot of the software app smoking material counter consistent with certain embodiments of the present invention.

FIG. 7 is a screen shot of the software app goal tracking graph consistent with certain embodiments of the present invention.

FIG. 8 is a screen shot of the software app indicating reporting of the use of smoking material not taken from a smart case displayed on a map indicating the location of the event consistent with certain embodiments of the present invention

FIG. 9 is a screen shot of the smart case properties as communicated to and displayed in the software app consistent with certain embodiments of the present invention.

FIG. 10 is a screen shot of the context information for habits the software App may collect from the user consistent with certain embodiments of the present invention.

FIG. 11 is a screen shot of the status messages presented to the user by the software App consistent with certain embodiments of the present invention.

FIG. 12 is a screen shot of the system dashboard screen display presented on the system server consistent with certain embodiments of the present invention.

FIG. 13 is a screen shot of the system status screen display presented on the system server consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “smoking materials” refers generally to products containing nicotine, and, more specifically, may refer to cigarettes, cigarillos, cigars, or any other materials that contain nicotine, in addition to nicotine replacement products such as, in non-limiting examples, varenicline, bruproprion and other nicotine replacement materials, to be ingested by a user.

The present invention is in the technical fields of handheld devices and behavior modification. More particularly, the present invention is in the field of ending the use of nicotine products, and more specifically referencing smoking cessation technologies. The system and method include a system server having a processor, data storage, and active software management modules, and a smart electronic device linked with a smart phone app that helps people quit smoking.

In an embodiment, the system and method may consist of a hardware device that may be a case into which smoking materials may be placed, a system server having a processor, data storage, and active software management modules, and an application that may be downloaded to a smartphone, iPad, tablet, or other wireless, handheld device. The case is a smart case in that it may contain sensors to assist in the determination and tracking of smoking materials that are placed within and removed from the smart case. The smart case may also have a processor and memory, as well as a communication capability to permit the smart case to track smoking activities and transmit that information by communicating with an outside processor.

In this embodiment, the system and method provides smokers a more effective way to quit smoking by helping them understand when, where, and in what context they are likely to smoke, predict, based upon the smoker's habit information, when, where, and in what context they will smoke and provide an intervention to deter smoking. When the system is enabled with a smart case, the system and method may utilize the interaction with the smart case to provide control over access to smoking materials by locking the smart case so as to deny access to smoking materials contained within until certain conditions or timing are met. The backbone of the product is a unique, hardware device, the smart case, which in some embodiments may be lockable. The smart case may be connected wirelessly to a smoking cessation software application that is available on the smoker's smartphone, iPad, tablet, or other wireless device. In an embodiment in which the system includes a smart case, the focus of the system is not necessarily to limit access to the addictive substance, but to track consumption, and provide the user with positive feedback and tailored interventions at critical moments to assist them in achieving behavioral change.

The system and method includes the ability to track a smoker's habits. The system and method may collect data points that provide information on when, where and how many cigarettes are smoked. It will also be able to track close proximity human density to show how many people may have been affected from second hand smoke due to the smoking activity of the user of the system. It may also be able to track when a user is physically near friends who smoke and who are also system users, or contacts in other social networks that share their location information with the user is some manner that may be accessed by the system. Many other types of data, including but not limited to the context of the event and the intensity of a craving, may be appended to a particular smoking event using two methods:

a) Automatically by the system, using electronic sensors in the hardware device and smartphone app.

b) Manually, by the user, through provided user interface elements in the smoking cessation software application.

The system and method may provide a smoker with social support. Through interaction with the device and the smoking cessation software application downloaded to the smoker's smartphone, the smoker will be a part of a rich community of smokers that are trying to quit. The smoker may be grouped with other users based on a large number of relevant factors, including but not limited to demographics (age, gender, etc.), health history, smoking patterns, nicotine dependence, location, preferred quit date, NRT use, and motivators to quit. Smokers may receive assistance from their family members and loved ones. The product may also be able provide social support by assigning one or more quitting buddies or mentors from the community according to each smoker's habits with whom the smoker may have an affinity. The social support may be in the form of an ex-smoker, or a current smoker also attempting to quit, with whom the smoker may share experiences and look to for support in the struggle to quit smoking.

The smart device into which the smoker stores smoking materials may have sensors, tracking capability, communication capability, and a locking feature. When locked into the device, smokers do not have access to smoking materials, such as, in a non-limiting example, cigarettes, during the time that the craving is strongest, or during habits that are triggers for smoking activity. The hardware device can lock automatically if a smoker is over their daily goal or they are near identified triggers. Smokers may use the smartphone App to unlock the smart case only after a short time interval has passed, or after a small task is completed. These capabilities may help smokers overcome their triggers, gain awareness about impulsive actions, and help them learn coping strategies. Smokers would be able to unlock the device containing the smoking materials by activating the software application on the smartphone and performing one or more activities designed to call the smoker's attention to their smoking habit.

The system and method enables feedback and intervention at critical moments. The system and method is able to detect smoking events in real-time, including when a user accesses the smart case, and when a user removes cigarette material from the smart case. It also empowers the user to manually report smoking events including but not limited to the consumption of nicotine from an untracked source, the onset of a craving (and related intensity and context), and a subjective need for feedback or support. The system and method is further able to predict, based upon data about the smoker's habits both automatically gathered through the use of the system and reported by the smoker, when, where, and it what context the smoker is most likely to smoke or when, where, and it what context they are most likely to access the smart case. The system may also be able to compare and analyze the smoker's specific behavior in context of broader data analysis from a large population of smokers. Furthermore, that aggregate data describing large populations of smokers (likely anonymized to protect individual users) can be delivered to counselors to inform their cessation strategies and to understand smokers in their locale, and to inform smoking cessation research generally.

In this embodiment, when the system predicts or determines an intervention or feedback should be provided to the smoker, the software application will be able to distract the smoker with a funny video, article, game, etc. during their craving time. Additionally, or alternatively, motivational text and multimedia messages, and educational content may be provided to the smoker as part of the intervention. These can be automatically generated by the system, or crafted by a cessation professional/counselor, and are tailored to the smoker. These feedback and interventional messages and activities may help smokers to be aware of the context, time, and location that may trigger their smoking habit, and to permit them to effectuate behavioral change.

In an exemplary embodiment, the system and method may also be able to provide personalized cessation plans according to smoker's habits. The personalized cessation plan may be automatically generated by the system and be created and/or tweaked by a cessation counselor both at the beginning of the cessation journey, and as a smoker's needs/habits change over time. The personalized plan may be based upon a collection of proven methods and strategies that are most likely to be successful for any particular smoker. Methods and strategies include, but are not limited to, the establishment of daily smoking limits that most effectively help the smoker reduce from current number of smoking materials per day to zero, suggested use and scheduling of NRTs, the provision of educational materials (science of nicotine addiction, strategies to avoid/beat cravings, best practices for using the system, etc.), and a schedule of counseling intervention (intensity, # of contacts and length of contacts per week).

In a non-limiting example, a smoker can get in touch with a counselor to get expert advice through the software App that is associated with the system. Whether or not a user decides to contact a counselor, the system and method may devise and present to the user a customized smoking cessation plan. The customized smoking cessation plan may be used in conjunction with advice from an outside counselor, or a user may follow the plan on their own to proceed with quitting the smoking habit. In this embodiment, the software App may connect the user to a social network of other quitters, ex-smokers, friends, and counselors. This social network may form a comprehensive supportive network that a smoker can turn to for advice and support for any situation with which they find themselves struggling.

In an embodiment, the system and method provides real time support through the software application associated with the system. The software App on the smoker's smartphone may also display a notification, text message, or alert right before smoker is about to smoke. The system and method collect metrics to be able to understand smoker's habits more thoroughly, from the perspective of habit driven behavior, and may provide an ability to tailor cessation plans to a degree that has not been possible before. The system and method may provide real time support through a software application that is always available to a smoker on a smartphone or other mobile device, which a smoker is already carrying on their person. No other cessation product, app, or counselor is able to intervene at critical moments by detecting when a smoker is about to consume smoking material, or predicting such an event through real-time data analysis.

In an additional embodiment, the system and method aims for long-term success and may provide for long term support to assist smokers after they have stopped smoking. Ex-smokers will stay connected to the social support network via the software application to make sure they are still on track for a period of time after quitting. Once the smoker reaches the goal of reducing their use of smoking materials to zero, the smoker may still receive information and advice regarding smoking abstinence through the software application as a user of the system. The smoker may continue to consult or seek help as cravings for nicotine arise in the future. The smoker may also become a helper or counselor to other people trying to quit.

This exemplary embodiment presents a system and method for modifying behavior by establishing wireless communication between a software app installed on a mobile device where the mobile device is in wireless communication with a system server and the smoking materials container device. The system and method provides a user with a personalized habit tracking data created by collecting data when a user interacts with the smoking materials container device, the collected data associated with use or non-use of smoking materials stored within the smoking materials container device. The system and method compares the use of smoking materials against the user habit tracking data and analyzes collected smoking activity data to predict the next interaction of the user with the smoking materials container device. The system and method may also provide feedback and interventional messages, materials, and information to assist the user in meeting a predetermined cessation goal and effect behavioral change.

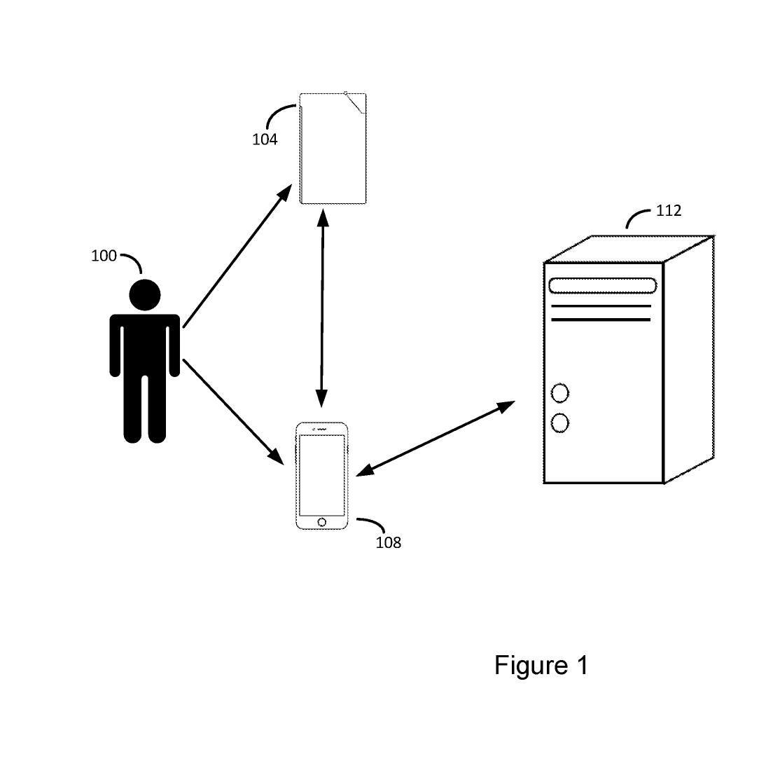

Turning now to FIG. 1, this figure presents a view of an exemplary system component configuration consistent with certain embodiments of the present invention. In an exemplary embodiment, a user 100, defined as a smoker determined to quit smoking and set a goal to stop smoking tobacco or using tobacco, may acquire a smart consumption tracking device, such as, in a non-limiting example, a smart case 104, and download the software application to a handheld device 108 associated with the user. The smart case 104, in one implementation of the smart consumption tracking device, may be a case of sufficient dimension to insert and hold a certain quantity of smoking materials. This quantity, in a non-limiting example, may be equivalent, in terms of nicotine content, to a standard pack of cigarettes. The smart case 104 may also have installed a processor and wireless communication element, infrared (IR) and hall-effect sensors, as well as a magnetic closure element. The smart case 108 operates in conjunction with the software application to determine when the user 100 first interacts with the smart case 108, such as by opening the lid to remove one or more smoking materials. The handheld device 108 may be a smart phone, iPad, tablet, or any other handheld device capable of downloading and operating the software application associated with the smoking cessation system.

In this embodiment, the user 100 may establish a wireless communication connection between the smart case 104 and the application operational on the handheld device 108. The handheld device 108 may establish a two-way wireless communication connection with the system server 112. The system server 112 may contain the system control software, all databases containing information collected from each individual user 100, analytic software to collect and mine the user data forming the basis for the predictive analytics associated with each user's habits, and all other system management capabilities. Additionally, the system server 112 may include analytic software to analyze aggregate data, and determine trends in large smoking populations. The aggregated data may then be fed into the analysis of individual user data, along with other analytical uses for the collected data. Upon establishment of all communication connections, the system becomes active to work with the user 100 to establish and manage the goal of smoking cessation. The quit date or duration of the smoking cessation plan may be selected by the user, the system, or the counselor, individually or in a collaborative fashion with input from the user, system, and/or any counselor involved with the plan.

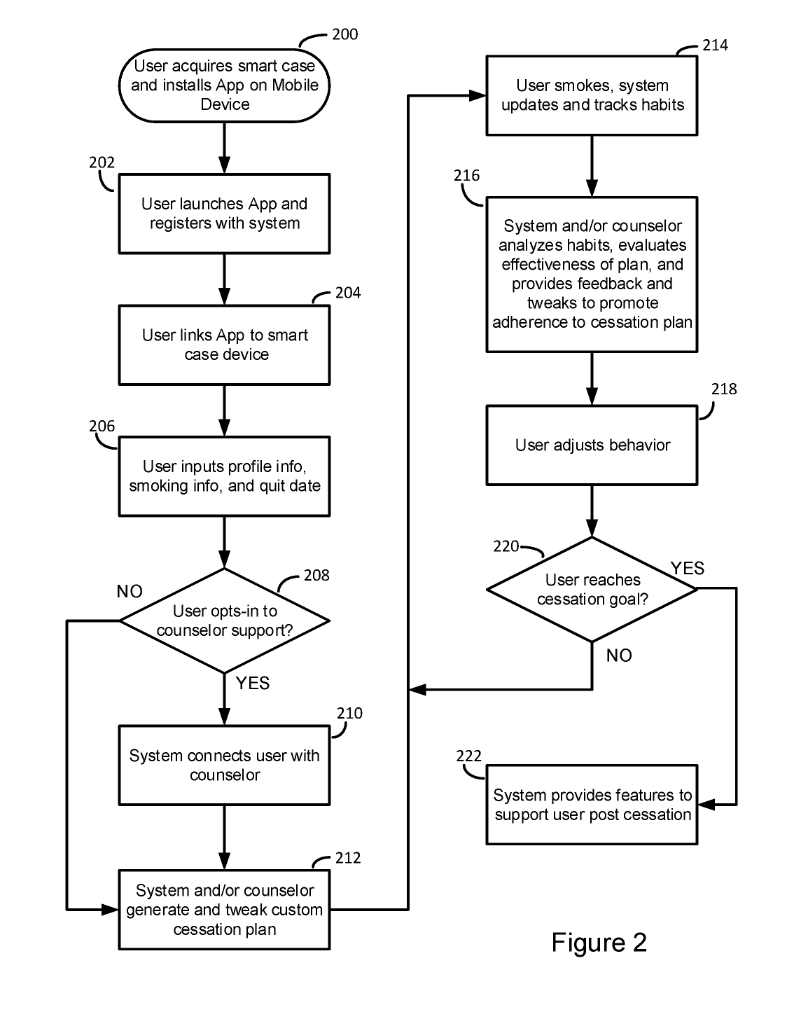

Turning now to FIG. 2, this figure presents a flow diagram for the smoking cessation application operation consistent with certain embodiments of the present invention. In an exemplary embodiment, at 200 a user, who is a smoker or is setting goals with permission of the smoker, acquires a smart case and installs the smoking cessation application on a mobile device associated with the smoker. In this exemplary embodiment, smoking materials have been loaded into the smart case and the smart case is awaiting operational information. At 202, the user launches the software app on their mobile device and registers with the smoking cessation system management software on the system server.

In this exemplary embodiment, at 204 the user interacts with the software app to link the software app to the smart case. The link establishes a bi-directional communication link through the use of a wireless near field communication protocol such as Bluetooth, BlueTooth Low Energy (BLE), or any other wireless near field communication protocol between the smart case and the software app. The communication permits the user to input profile information, information about smoking habits and use of smoking materials, and a date by which the user wishes to quit smoking at 206. The software app may provide the user with the option to select a human counselor to provide support to the user while the user is trying to quit smoking at 208. The user may elect to meet with a human counselor and the system may connect the user with a counselor at 210, permitting the counselor to interact with the user through the system via a counselor dashboard web app provided by the system server.

Whether the user elects to interact with a human counselor or not, the system may then create and generate a custom smoking cessation plan for the user at 212. The custom smoking cessation plan is formulated to meet the user's goals for both use of the smoking materials and meeting the date upon which the user has indicated that they wish to be an ex-smoker. After transmission of the custom smoking plan, at 214 the user follows the cessation plan, where the cessation plan is a series of daily limits (or goals) on number of smoking materials used that gradually tapers to zero over time. On top of this, the cessation plan includes a strategy of intervention and feedback at critical moments to assist the smoker in adhering to his/her daily limits by overcoming cravings and preventing nicotine use events. That intervention and feedback comes from the system automatically and from the counselor. Further pieces of a robust cessation plan can include NRTs, where nicotine dependence warrants it, and regularly provided educational materials. The time, place and context provide information to the system about the user's nicotine use, including smoking, habits which are stored in the system database file for the user. At 216, the system, in conjunction with a human counselor if the user has elected to have counselor support, analyzes the smoking habits of the user. The system provides feedback to the user through informational displays presented by the software App on the mobile device associated with the user. The feedback is intended to promote adherence to the smoking cessation plan by providing information as to when and how the user is meeting or missing the milestones established in the smoking cessation plan. At 218, the user may modify behavior based upon the feedback provided by the system on the software App display.

In this embodiment, as the user's quit date for smoking is reached, the system determines whether the user has quit or is still smoking at 220. This information may be used to present the user with an updated custom smoking cessation plan and the user may once again begin to smoke and track habits based upon the updated smoking cessation plan to reach a newly established quit date.

If the user has been successful in meeting their established quit date for smoking, at 222 the system will log this successful result. The system may also place the user in the system to initiate long-term post smoking support. These features present the user with continued smoking cessation support long after the user has met their goal to quit smoking. In a non-limiting example, one such feature would be the provision of educational materials targeted at post-cessation, or continued, intermittent access to a counselor. The long-term support features may also provide the user with the ability to become a mentor to another user who is attempting to successfully quit smoking.

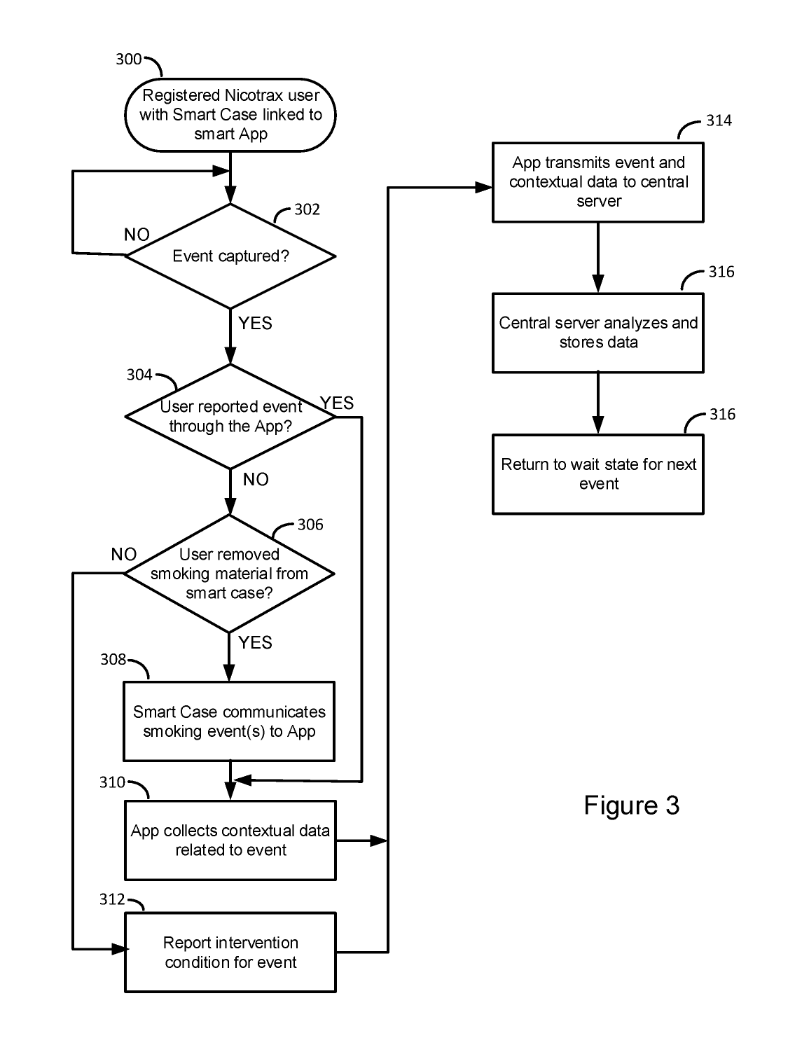

Turning now to FIG. 3, this figure presents a flow diagram for the operation of the software App within the system consistent with certain embodiments of the present invention. In an exemplary embodiment, at 300 a user who is registered with the smoking cessation system may establish a bi-directional communication connection linking a smart case in use and the mobile device associated with the user. At 302 the system is in a wait state, waiting for an event such as the opening of the smart case, or the user reporting a smoking event that did not involve the removal of smoking materials from the smart case, such as receiving smoking materials from a source outside of the smart case.

In this embodiment, at 304 the system receives an indication that the user is reporting a smoking event through the software App installed on the mobile device associated with the user. The event may be the receipt of smoking materials from an outside source that the user then smoked, an indication he/she is experiencing a nicotine craving, or an indication that a previous smoking event was improperly recorded. This can occur, for example, if the user incorrectly self-reports a consumption event, or if the user removes smoking material from the smart case, but does not consume that material. The event reported to the system may include, but is not limited to, information such as whether the user smoked, whether the source of the smoking material was the smart case or external, where the user was located, what time the event occurred, and possibly the activity and social context in which the user was engaged when the event occurred. This event information is captured by the software app on the mobile device and transferred to the management software on the system master server.

In this embodiment, at 306 the user is not reporting an event, but rather the occurrence of an event is triggered by the user removing smoking materials from the smart case. If an event occurs, such as the user opening the smart case, the removal of smoking materials, or the opening of the smart case without the removal of smoking materials, the smart case communicates the event, including data regarding time, location, and removal or non-removal of smoking materials to the software app at 308. If the user opens the smart case, but does not remove any smoking materials from the smart case, an indication of this event is reported to the software app as a possible intervention condition at 312, although it is not the only moment in which an intervention may be performed. In a non-limiting example, the intervention condition may be one of the indicators of a critical moment during which to provide behavioral intervention (the user has indicated a potential desire to smoke, but has not yet consumed the smoking material). The smart case communicates to the system when the lid is opened. This is a critical moment for intervention, and an intervention is delivered. The user may then continue with his intent to smoke a cigarette, removing one or more smoking materials from the smart case. He may otherwise simply close the lid without removing any smoking materials. Whether the user removes one or more smoking materials from the smart case or not, an intervention is initiated when the smart case lid is opened.

At 310, the software app collects the contextual data previously enumerated related to the event such as time, place, and activity information. At 314, the software app may transmit the event, any error condition, and all contextual data such as time, place, and activity information from the software app to the master management software on the system server.

At 316, upon receipt of the event, intervention condition, and contextual data from the software app, the system server may activate software modules to store the data and associate the incoming information with a particular user. The system server may also activate software modules to analyze the stored data for updates, changes, or predictions for the user. The software app having completed the reporting of the event may then return to a wait state to wait for the next scheduled, reported, or predicted event at 318.

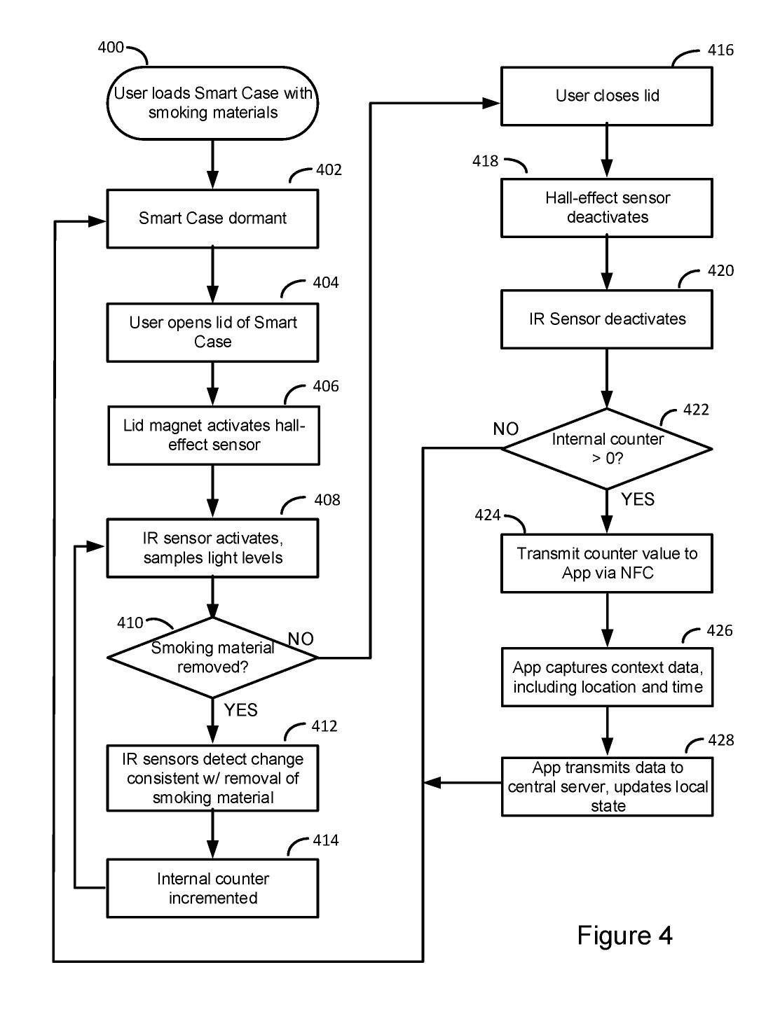

Turning now to FIG. 4, this figure presents a flow diagram for the operation of the smart case within the system consistent with certain embodiments of the present invention. In a non-limiting example, a user who wishes to quit smoking acquires a smart case and loads the smart case with smoking materials at 400. The smart case is dormant and in a wait state at 402 in the absence of any scheduled or predicted action. In this embodiment, at 404 a user may open the smart case lid at any time to remove one or more smoking materials. Opening the smart case lid disengages the magnet that secures the closure of the lid and activates a hall-effect sensor installed within the interior of the smart case at 406. At 408, the smart case activates an infrared (IR) sensor to sample the light levels when the lid is first opened. A change in light level is captured by the IR sensor when smoking materials are removed from the smart case.

In this embodiment, at 410 the user may remove an individual smoking material from the smart case via the lid opening in the smart case. The change in light level is recorded as the smoking material moves by the IR sensor and this detected change in light level correlates with the removal of smoking material from the smart case at 412. At 414, an internal counter tracking the amount of smoking material contained within the smart case is incremented to indicate the removal of the smoking material from the total contained within the smart case, compiling an indication of the number of times the user has opened the case to remove smoking materials. Having successfully retrieved a smoking material portion from the smart case, the user may then close the lid on the smart case once again at 416.

In this embodiment, when the lid is closed the hall-effect sensor deactivates at 418 and the IR sensor deactivates at 420 to await the next scheduled or predicted smoking event for which the user may open the smart case.

If the internal counter indicates a value of zero at 422, the system returns to the smart case dormant state at 402. If the internal counter indicates a non-zero value at 422, the counter value is transmitted from the smart case to the software app at 424 via the bi-directional communication connection between the smart case and the mobile device upon which the software app is active. At 426, the software app captures all context data, including location, time, and activity information. Upon collection of the context data, at 428 the software App transmits all context data to the master management software on the system server and updates the local state information maintained by the software App.

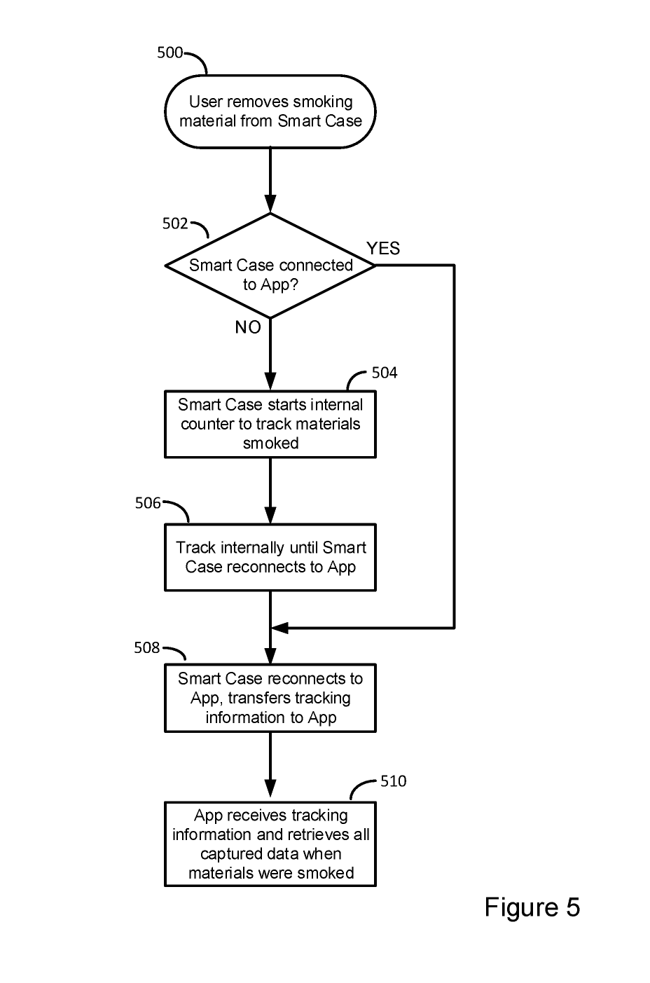

Turning now to FIG. 5, this figure presents an operational flow diagram for software App operation when not connected to the smart case consistent with certain embodiments of the present invention. In this embodiment, at 500 the user may remove a portion of the smoking material contained within the smart case. At 502, the smart case attempts to determine if there is an active bi-directional communication connection between the smart case and the software app installed on the mobile device associated with the user.

In an exemplary embodiment, if the communication connection between the smart case and the software App has not been established, or has been broken after once having been established, the smart case at 504 starts an internal counter maintained in the processor installed within the smart case to track materials removed from the smart case. All materials removed from the smart case are presumed to be removed for smoking purposes. At 506, the software app continues to monitor the communication connection to determine when the bi-directional communication connection has been reestablished with the smart case. Upon a successful connection, the smart case then performs a complete data transfer and returns to normal operation. The smart case continues to track the removal and smoking of smoking materials from the smart case during the time when there is no communication between the smart case and the software app.

In this embodiment, when bi-directional communication connection is reestablished between the smart case and the software app at 508, the processor within the smart case transfers all collected tracking information from the smart case to the software App. At 510, the software app receives the tracking information and retrieves all captured data recorded by the smart case regarding when smoking materials were removed from the smart case and consumed.

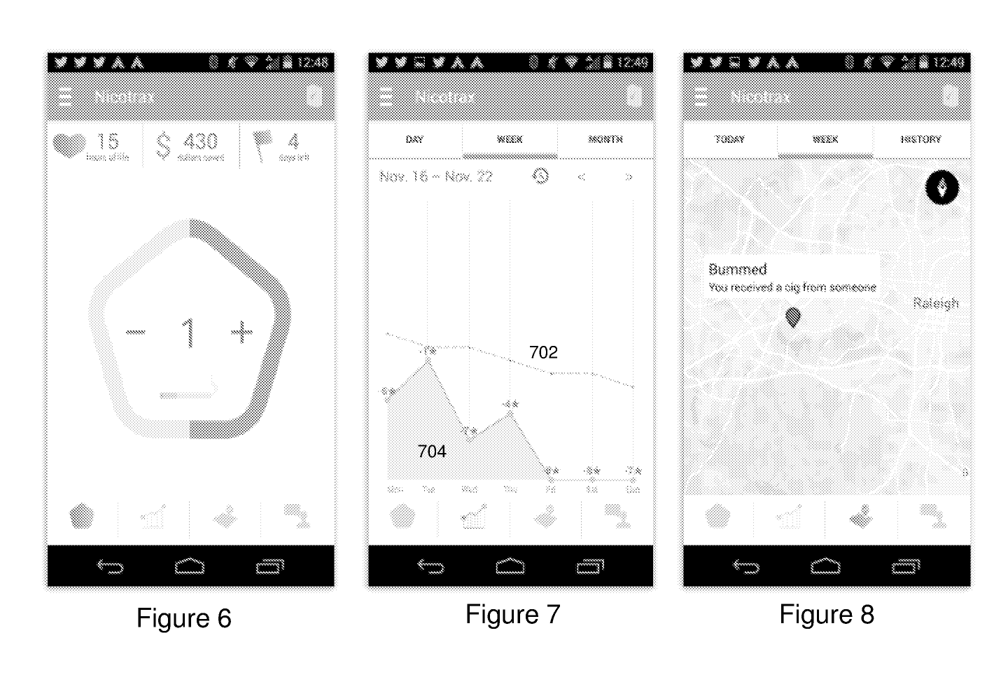

Turning now to FIG. 6, this figure presents a screen shot of the software app smoking material counter consistent with certain embodiments of the present invention. In an embodiment, when a user establishes a daily consumption limit as a part of the cessation plan, these consumption limits are reduced day-by-day to slowly wean the smoker off of smoking materials. The software app tracks and manages a counter to provide the user with information concerning how closely the user is adhering to the established goal and quit date. The software app, through communication with the smart case, keeps track of how many smoking events a user has in a given time period. The counter maintained by the software app is incremented each time a smoking activity takes place and this screen display presents the current value of the counter with respect to how many smoking activities the user is supposed to have had during the relevant time period. In a non-limiting embodiment, the user may also add smoking materials to the smart case and decrease the counter in the software app. The counter thus provides the user with a graphical representation of how they are progressing by displaying how many smoking activities “ahead” or “behind” the goal the user has set. This display is a status that a user may take in at a glance to provide instant feedback on how they are doing in meeting the established goal. The instant display may also provide user interface controls to allow self-reporting of smoking events (including cravings), and motivational metrics including a computed savings in the form of hours added to life, money saved on cigarettes, and days left in the user's cessation plan.

Turning now to FIG. 7, this figure presents a screen shot of the software app goal tracking graph consistent with certain embodiments of the present invention. In this embodiment, the user is provided with a graphical representation of progress in reaching the established quit date. The custom cessation plan for the user provides the graphed expectation curve 702 if the user follows the custom cessation plan for smoking activities and how the smoking activities must decline over time to meet the quit date goal. The tracking information gathered each time the user opens the smart case and removes smoking material is graphed on the lower curve 704. The graphing of these two curves on the same graph provides the user with a graphical presentation of how well the smoker is performing with respect to the expectation established by the custom cessation plan. In this non-limiting example, for the established time period, the smoker is below the expectation curve and can use this display as additional feedback and motivation.

Turning now to FIG. 8, this figure presents a screen shot of the software app indicating reporting of the use of smoking material not taken from a smart case displayed on a map indicating the location of the event consistent with certain embodiments of the present invention. In this exemplary embodiment, the user may self-report smoking events that occur outside of the custom cessation plan provided to the user by the system. The most common occurrence is the receipt of smoking materials that have been received from other individuals or sources other than those stored in the smart case associated with the smoking cessation system. This screen provides a display for the user to show the time, location and any other contextual information provided by the user when reporting a smoking event using smoking material received from an outside source. The user may review this display, or may present this display to a counselor, to receive feedback about events that are not being tracked by the smart case and that may be impacting the user's achievement of the smoking cessation goal.

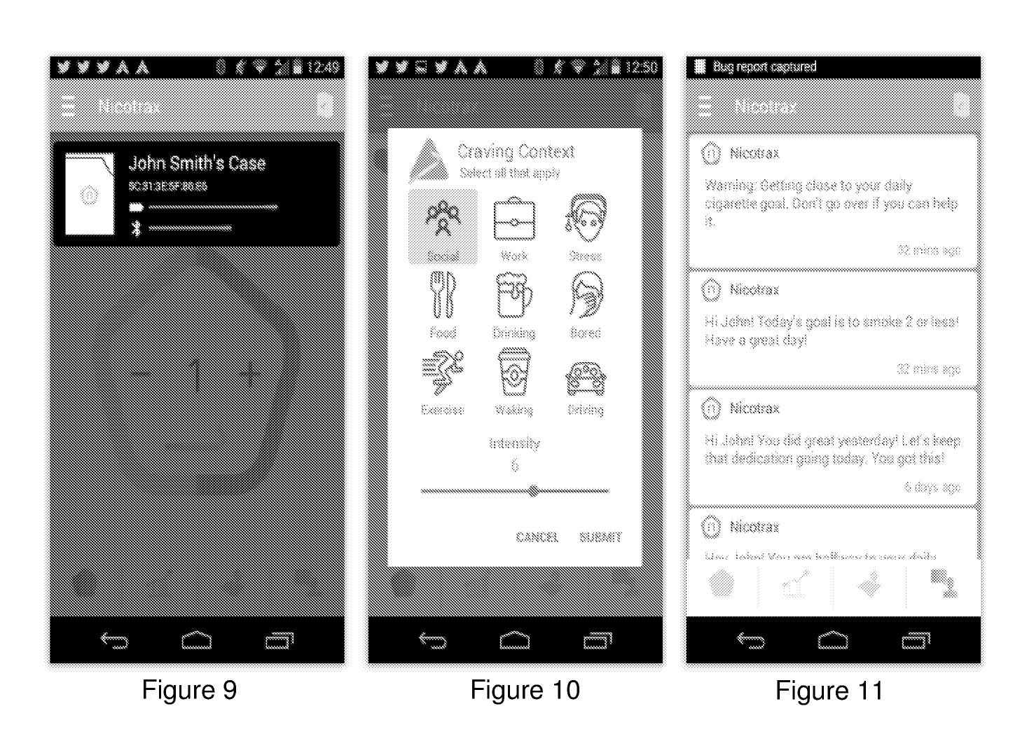

Turning now to FIG. 9, this figure presents a screen shot of the smart case properties as communicated to and displayed in the software app consistent with certain embodiments of the present invention. In this exemplary embodiment the software app may provide the user with informational properties associated with a smart case with which the software app is connected. In this informational display, the user is presented with the machine identifier for the smart case, the battery status for the charge level of the battery in the smart case, and an indication of the strength of the wireless connection signal. In an alternate embodiment, this display may also provide an indication for the number of cigarettes remaining in the smart case or if the smart case is empty. The user may select this display to determine at a glance the smart case to which the software app is connected and the status of the smart case.

Turning now to FIG. 10, this figure presents a screen shot of the context information for habits the software app may collect from the user consistent with certain embodiments of the present invention. In an exemplary embodiment, user cravings to smoke may not be triggered just by the lack or lessening of nicotine in the user's bloodstream. It has also been established that many times a user will smoke based upon situations, locations, or physical conditions other than lack of nicotine. These situations, locations, or other physical conditions present psychological conditions under which a craving to smoke may have been formed as a habit. Placing a user in these situations, locations, or physical conditions thus serves to trigger the desire to smoke based upon the habit formed over time. The display presented in this figure provides the user an ability to input contextual indications for when the user may have a craving to smoke, or may have actually smoked or otherwise consumed smoking materials. The display presents the user with craving context icons that the user may select to capture the data about when the user habitually smokes. Conditions including, but not limited to, social events, stressful events, when a user is eating, exercising, or drinking, as well as occasions when the user is bored, at work, or simply driving may be captured as trigger events for the user. The user is also able to indicate the intensity of the craving that is associated with each trigger event selected by the user. When the user has completed selecting all trigger event icons that apply to the user, as well as the intensity level for each trigger event, the data is stored within the software app as contextual data. The software app also transmits all craving context information to the system server to form a portion of the behavior data base for use in creating predictions for when a user may be experiencing a craving to smoke. With this contextual information, the predictive analysis module in the system server may direct the transmission and display of feedback or interventions on the display of the mobile device associated with the user when craving triggers are identified and prior to the user actually smoking. These interventions may consist of, among other things, supportive text or multimedia messages and/or games, and may help the user to resist smoking and to effect meaningful behavioral change.

Turning now to FIG. 11, this figure presents a screen shot of some status messages including motivational content presented to the user by the software app consistent with certain embodiments of the present invention. In an exemplary embodiment, the software app presents the user with status messages that are provided as instruction, feedback, and motivation for the user. Messages may be transmitted to the user indicating the goals to be met for the day, status messages on where the user is in regard to meeting the user's goal, inspirational messages to help keep the user on track and other messages that assist the user in staying focused on achieving their goal to stop smoking. These feedback and status messages may be turned on or off and are presented on the display of the mobile device that is connected to the smart case and the system server. This display screen may also present messages from the user's counselor, and can include motivational images and multimedia among other displayed information.

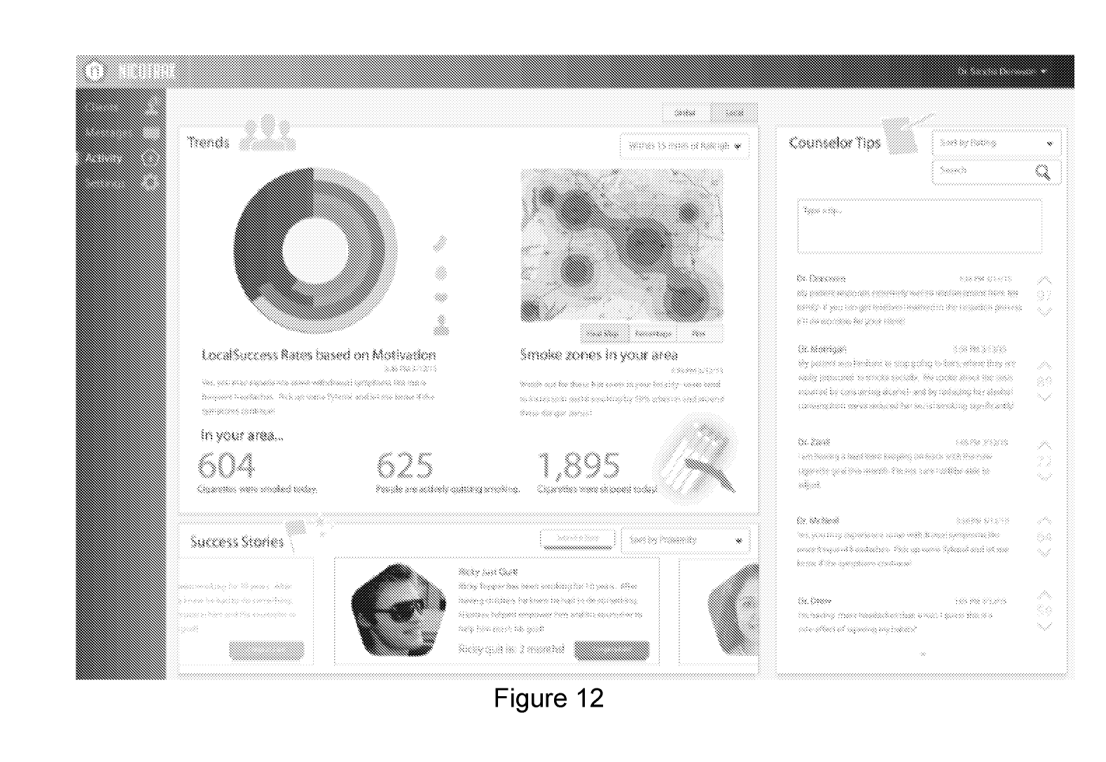

Turning now to FIG. 12, this figure presents a screen shot of the system dashboard screen display presented on the system server consistent with certain embodiments of the present invention. In an exemplary embodiment, the system server provides status, metrics, information, and celebratory messages to users who log into the web presence maintained by the system server. The web presence provides users with access to a system dashboard that maintains the information and provides access to the information that has been created from one or more analyses performed on aggregated data from all individuals using the system.

In this embodiment, the system dashboard may provide users with trend information for all aggregated data currently available. The trend information may provide metrics such as, in a non-limiting example, success rates by region. In this non-limiting example, additional trend information may include maps of geographic areas and the relative level of smoking activity across all tracked smokers in a given geographic area, represented in different visual means such as a heat map, which provides the level of activity in circles having increasingly darker or more intense shading based upon a greater level of activity, or pinned to particular locations. These metrics provide information for the relative level of smoking activity in a given geographic area such that those who are trying to quit, or cessation professionals hoping to assist smokers within their geographic area or otherwise study the patterns of smoking in a co-located population, may have some idea of how many active smokers are in an area, or to what level smoking activity takes place over time in said area. Additional metrics provided by the system dashboard may include pure statistical data such as the number of smoking materials consumed, the number of smokers attempting to quit, and some estimation of the number of smoking materials that were passed over in favor of quitting in a geographic area of interest to the user.

In this embodiment, the system dashboard may also present inspirational messages, such as success stories, to assist users in maintaining resolve to reach the goals set in their individual smoking cessation plan, or to inform cessation counselors' approaches to assisting other users. These inspirational messages may also be sorted and presented by geographic areas that are in proximity to a particular user such that the user may feel a closer connection to others in his/her area that are experiencing the same issues as the user. The inspirational messages may present individual case histories for given users who are using the smoking cessation system as information to help bolster the resolve of a user in meeting his/her own cessation goals.

The system dashboard may also provide information to users that is of a more general nature. In a non-limiting example, counselors may use the system dashboard to share tips regarding effective methods in assisting smokers with the use of the system or with quitting. In another non-limiting example, the system dashboard may provide counselor tips that are suitable for dissemination to all users of the system. A user may read the provided tips and act upon those that apply to their own personal situation, even though the tips are provided for a general audience.

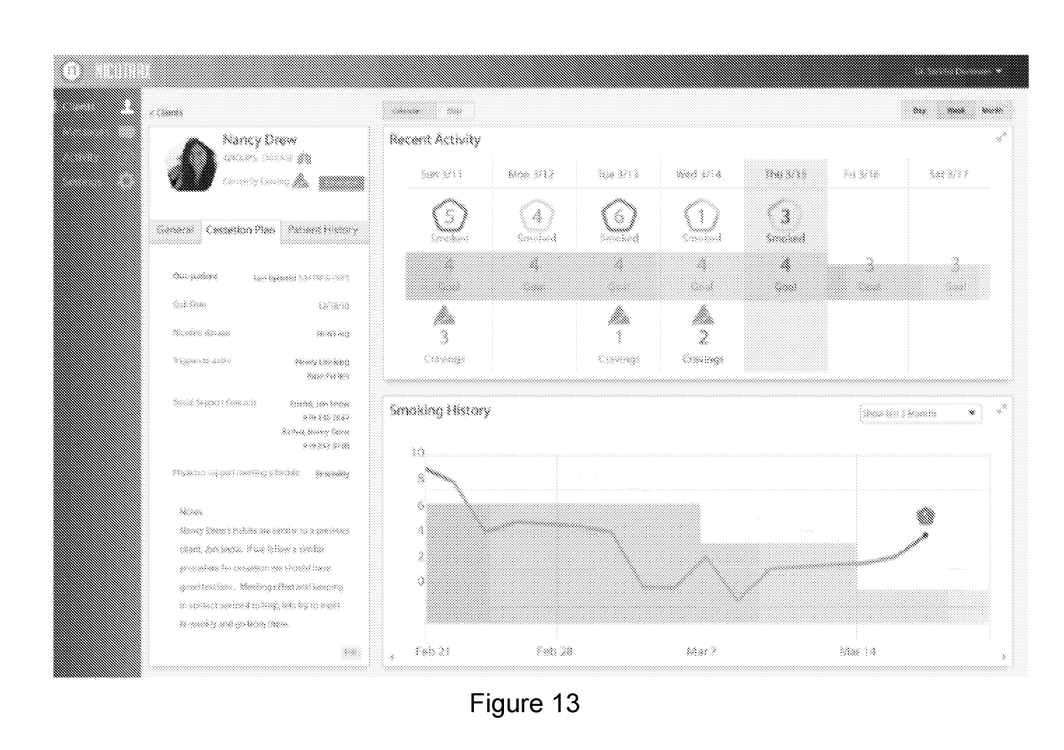

Turning now to FIG. 13, this figure presents a screen shot of the system dashboard status screen display presented on the system server consistent with certain embodiments of the present invention. In an exemplary embodiment, the system server records, stores, tracks, and analyzes all context and activity data for each user of the smoking cessation system. Upon request by a system user, system administrator, counselor, or the like, a display providing a snapshot of a user's progress may be presented by the system server. In a non-limiting example, the system user may input the name or other identifier for a user of the system 1202 and be presented with the snapshot of progress for that user.

In this embodiment, the snapshot may present general information about the user 1204 such as gender, when the user started and/or stopped smoking, how long the user has been using the system, smoking activity on average, and a quick view of the motivators that are important to the user. This general information is restricted to system users and counselors that have permission or consent from the user to review this information. The snapshot information may also include a timeline of recent smoking activity 1206 and a graphical representation of the user's smoking history 1208. This information may assist a counselor in assisting a user to achieve their goal to stop smoking. Additionally, the information may present the system user, such as a system administrator, to determine if there are any issues or problems with the data that has been captured and stored within the system.

While certain illustrative embodiments have been described, it is evident that many alternatives, modifications, permutations and variations will become apparent to those skilled in the art in light of the foregoing description.

What is claimed is:

1. A system, comprising:
a smoking materials container device storing smoking materials;
a software app installed on a mobile device, said mobile device in wireless communication with a system server and the smoking materials container device;
the smoking materials container device interacting with the user to collect data associated with use of smoking materials stored within said smoking materials container device;
a software module for comparing the ongoing use of smoking materials against a user's previously determined habits;
a software module for analyzing collected smoking activity data and predicting the next interaction of the user with the smoking materials container device.

2. The system of claim 1, where the smoking materials further comprise materials containing nicotine including cigarettes, cigarillos, cigars, or any other materials that contain nicotine or are used as nicotine replacements to be ingested by a user.

3. The system of claim 1, further comprising a smoking materials container device in the form of a case having one or more sensor devices, a processor, a memory, and an openable portion for inserting and removing smoking materials.

4. The system of claim 1, where the mobile device comprises any of a smart phone, mobile phone, tablet, or other handheld wireless device having a display and an input capability.

5. The system of claim 1, where the software app is configured to interact with the user and the smoking materials container device to collect data from the user and from the smoking materials container device associated with smoking actions, timing, use of smoking materials, location, and other data associated with habits and patterns of use of smoking materials.

6. The system of claim 1, further comprising generating a smoking cessation plan with input from the user, with input from the system, and, optionally, with input from a smoking cessation counselor.

7. The system of claim 1, where the user's previously determined habits comprises a user determined smoking cessation goal with daily tracking on use of smoking materials reported to the software app by the user and the smoking materials container device.

8. The system of claim 6, where the smoking cessation plan may be updated, modified, and/or replaced as needed to meet the smoking cessation goal based upon tracking information reported to the software app.

9. The system of claim 1, where the analysis of collected smoking activity may be performed using an aggregated large data set, comprising data from more than one user, or from more than one cessation plan, upon which the system may base one or more predictions for interventions to be provided to any selected user through the software app on the selected user's mobile device.

10. The system of claim 1, the system further comprising connecting a user to one or more social support networks via the software application to provide additional support to the user in refraining from any further use of smoking materials.

11. A method for modifying behavior, comprising:
establishing wireless communication between a software app installed on a mobile device, said mobile device in wireless communication with a system server and the smoking materials container device;
providing a user with personalized habit tracking data;
collecting data when a user interacts with the smoking materials container device, the collected data associated with use or non-use of smoking materials stored within said smoking materials container device;
comparing the use of smoking materials against a user's previously determined habits;
analyzing collected smoking activity data and predicting the next interaction of the user with the smoking materials container device.

12. The method of claim 11, where the smoking materials further comprise materials containing nicotine including cigarettes, cigarillos, cigars, or any other materials that contain nicotine to be ingested by a user.

13. The method of claim 11, further comprising inserting and removing, or not removing, smoking materials from a smoking materials container device, where the smoking materials device comprises a case having one or more sensor devices, a processor, a memory, and an openable portion.

14. The system of claim 11, where the mobile device comprises any of a smart phone, mobile phone, tablet, or other handheld wireless device having a display and an input capability.

15. The method of claim 11, further comprising configuring the software app to interact with the user and the smoking materials container device, and to collect data from the user and from the smoking materials container device associated with smoking actions, timing, use of smoking materials, location, and other data associated with habits and patterns of use of smoking materials.

16. The method of claim 11, further comprising generating a smoking cessation plan with input from the user, with input from the system, and, optionally, with input from a smoking cessation counselor.

17. The method of claim 16, where the user's previously determined habits comprises a user determined smoking cessation goal with daily tracking on use of smoking materials reported to the software app by the user and the smoking materials container device.

18. The method of claim 11, further comprising analyzing collected smoking activity using an aggregated large data set, comprising data from more than one user, or from more than one cessation plan, upon which the system may base one or more predictions for interventions to be provided to any selected user through the software app on the selected user's mobile device.

19. The method of claim 11, the system further comprising connecting a user to one or more social support networks via the software application to provide additional support to the user in refraining from any further use of smoking materials.

20. A method for modifying behavior, comprising:
establishing wireless communication between a software app installed on a mobile device, said mobile device in wireless communication with a system server and the smoking materials container device;
providing a user with a personalized habit tracking data;
collecting data when a user interacts with the smoking materials container device, the collected data associated with use or non-use of smoking materials stored within said smoking materials container device;
comparing the use of smoking materials against the user habit tracking data;
analyzing collected smoking activity data and predicting the next interaction of the user with the smoking materials container device; and
providing feedback and interventional messages, materials, and information to assist said user in meeting a predetermined cessation goal and effect behavioral change.
